(19) United States
(12) Patent Application Publication
(10) Pub. No.: US 2009/0242550 A1
(43) Pub. Date: Oct. 1, 2009

(54) Self-Venting Microwave Heating Package

(76) Inventor: Lee M. Schneider, Menasha, WI (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/410,671

(22) Filed: Mar. 25, 2009

Related U.S. Application Data
(60) Provisional application No. 61/072,086, filed on Mar. 27, 2008.

(51) Int. Cl. H05B 6/80

(52) U.S. Cl. 219/730

(57) ABSTRACT

A package for heating, browning, and/or crisping a food item in a microwave oven, comprises a packaging material configured to define an interior space for receiving a food item, at least two portions of the packaging material being joined to one another to define a sealed area adapted to be situated above a lowermost portion of the food item received in the interior space, the sealed area being configured to weaken in response to thermal energy, and a microwave energy interactive material joined to a side of the packaging material facing the interior space, at least a portion of the microwave energy interactive material being disposed within the sealed area.

### CROSS-REFERENCE TO RELATED APPLICATION

This application claims the benefit of U.S. Patent Application No. 61/072,086, filed Mar. 27, 2008, which is incorporated by reference herein in its entirety.

### TECHNICAL FIELD

Various packages or constructs for heating or cooking a food item in a microwave oven are disclosed. In particular, this disclosure relates to various microwavable food packages that provide selective, controlled venting of moisture during the heating cycle.

### BACKGROUND

When a sealed microwave food package is heated in a microwave oven, the generation of steam and other gases typically causes the package to expand. If the internal pressure becomes too great and surpasses the strength of the material and/or the bonds forming the package, the package may burst open. This is particularly problematic where the package contains a liquid or semi-liquid food item that can leak from the package. Furthermore, in some cases, the formation of a tear or opening in the package may cause an excessive loss of steam needed for the cooking process. Thus, there is a need for a microwavable food package that selectively forms one or more openings in the package to provide the desired degree of venting without allowing the food item to leak from the package.

### SUMMARY

The present disclosure is directed to various packages for preparing a food item in a microwave oven. The packages generally are sealed to promote a buildup of pressure within the heating package to accelerate heating, to retain a desired level of moisture within the heated food item, and/or to inhibit spillage of the package contents.

The package includes at least one sealed area that is adapted to disjoin or disengage to define an opening for releasing water vapor and/or other gases that otherwise might cause the package to rupture. If desired, the disjoinable area may be positioned within the package in a manner that seeks to minimize leakage of the food item from the package. Further, the disjoinable areas may be dimensioned to prevent premature and/or excess loss of water vapor that may be needed for suitable preparation of the food item.

The disjoinable areas may include a microwave energy interactive element to alter the effect of microwave energy on the package. In one example, the microwave interactive element comprises a susceptor. Susceptor elements often are used to promote browning and/or crisping of the surface of a food item, but also may be used to increase the local temperature within a package, for example, along at least a portion of a sealed area, thereby causing the seal to soften and/or weaken. When the pressure inside the package reaches a predetermined level, a venting opening or vent preferentially forms in the weakened area. If desired, susceptor elements and/or other microwave energy interactive elements may be used in other areas of the package.

Various other features, aspects, and embodiments of the present invention will be apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic perspective view of an exemplary package for heating, browning, and/or crisping a food item in a microwave oven;

FIG. 1B is a schematic perspective view of the package of FIG. 1A, in a partially open configuration;

FIG. 1C is a schematic perspective view of the package of FIG. 1A, with a venting opening in the center seal;

FIG. 1D is a schematic top plan view of an exemplary sheet of packaging material that may be used to form the package of FIG. 1A;

FIG. 1E is a schematic cross-sectional view of a portion of the sheet of packaging material of FIG. 1D taken along a line 1E-1E; and

FIGS. 2A-2B schematically depict materials used to form a fin seal package and the package formed therefrom, for comparison with a package similar to the package schematically illustrated in FIG. 1A.

### DESCRIPTION

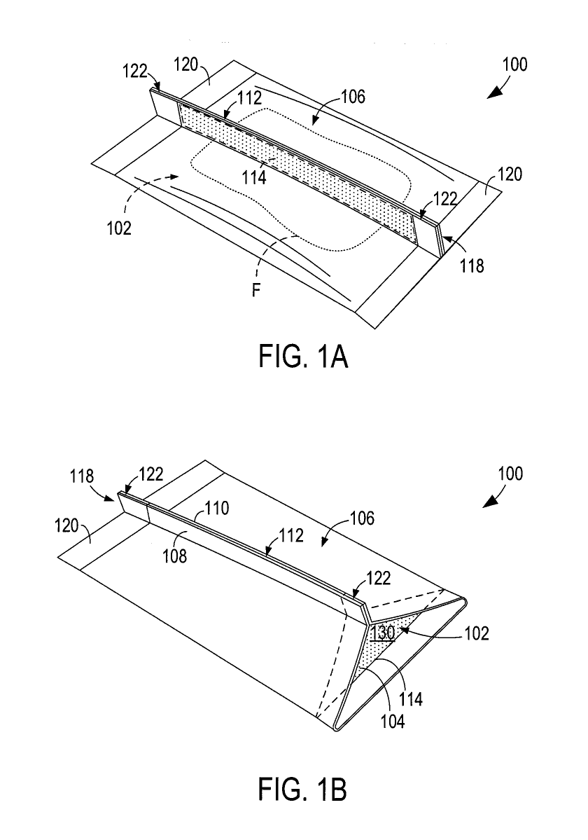

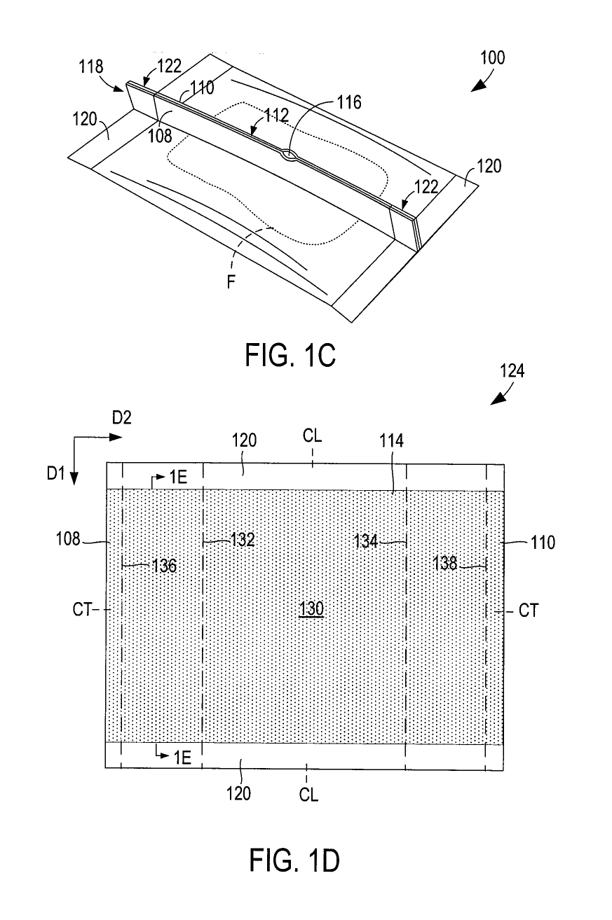

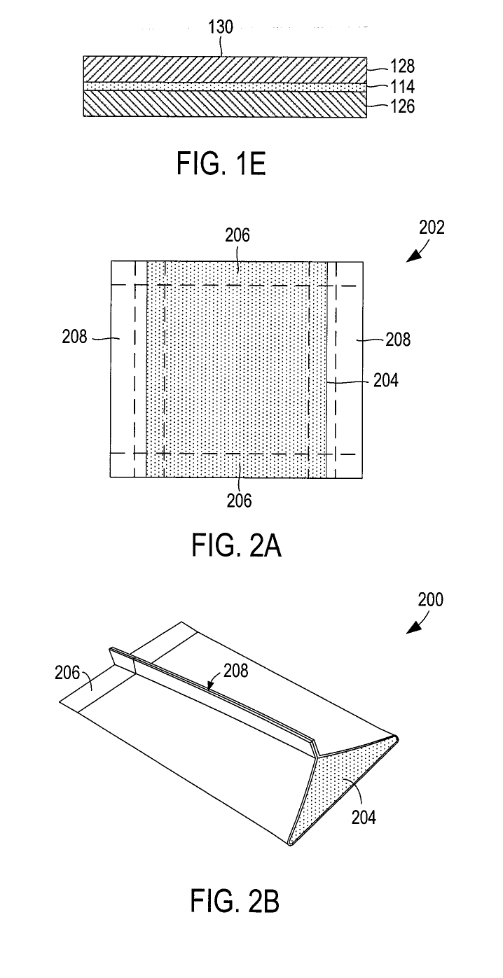

FIGS. 1A-1C schematically illustrate an exemplary package 100 for heating, browning, and/or crisping a food item in a microwave oven. As shown in FIG. 1A (with the package in closed state), the package 100 generally may be formed from a packaging material (for example, a flexible packaging material) configured to define an interior space 102 for receiving a food item F (shown with dashed lines). Any suitable food item may be heated within the package, for example, a meat and sauce, a stew, a breaded food item, pasta, vegetables, or any other suitable food item.

As shown in FIG. 1B, the package 100 may generally include a lower portion or base 104 adapted to underlie the food item, and an upper portion 106 adapted to overlie the food item. At least two sections or portions 108, 110 of the packaging material within the upper portion 106 of the package 100 are joined to one another to define a sealed area 112 that tends to weaken and/or disjoin in response to thermal energy.

The disjoinable seal or area 112 (or “disjoinably sealed area”) may be made to weaken in any suitable manner. In one example, the disjoinable area 112 may generally comprise a material that softens in response to sufficient heating, for example, a material having a softening point of at least about 250° F., for example, from about 250° F. to about 450° F. The package 100 also may include a microwave energy interactive material 114 within or proximate to the disjoinable area 112 (shown schematically with dashed lines and stippling in FIG. 1A) to facilitate weakening of the bond or seal in the disjoinable area 112.

The microwave energy interactive material 114 may be configured as a susceptor, i.e., a thin layer of microwave energy interactive material (generally less than about 100 angstroms in thickness, for example, from about 60 to about 100 angstroms in thickness, and having an optical density of from about 0.15 to about 0.35, for example, 0.21 to about 0.28) that tends to absorb at least a portion of impinging microwave energy and convert it to thermal energy (i.e., heat) at the interface with the food item. The thermal energy from the susceptor 114 raises the local temperature within the disjoinable area 112, thereby causing the bond between the adjoined portions 108, 110 of the packaging material to weaken. As the food item heats, any steam and other gases generated by the heating food item may generally cause the interior space 102 of the package to expand, thereby exerting a pressure on the weakened seal 112. When the pressure is sufficiently great, the adjoined portions 108, 110 of the packaging material may separate from one another at least partially to create a pathway, for example, a venting opening 116, for the steam and other gases to be released from the package 100 (FIG. 1C). In this manner, the pressure can be controllably relieved within the package 100 without causing the package 100 to rupture.

If desired, the susceptor 114 also may overlie other portions of the package to enhance heating, browning, and/or crisping of the food item. In the embodiment illustrated in FIGS. 1A and 1B, the susceptor (schematically illustrated with stippling) further 114 overlies at least a portion of the base 104 and upper portion 106 of the package 100 on a side of the packaging material facing the interior space 102, as indicated with dashed lines in FIG. 1B. However, other configurations are contemplated.

It will be appreciated that the size of the disjoinable area and/or the strength of the disjoinable area may be selected to minimize premature disjoining and/or excessive disjoining. Further, the disjoinable area may be positioned within the package to minimize the leaking of any sauces, liquids, or other exudates from the package. For example, the disjoinable area may be positioned within the package to be situated above a lowermost portion of the food item received in the interior space, where such liquids may typically collect.

In the illustrated embodiment, the disjoinable area 112 comprises a medial portion of a center or fin seal 118 of a fin seal type package, in which the center seal 118 generally extends transversely between and overlaps with a pair of end seals 120. The disjoinable portion 112 of the center seal 118 generally overlies the food item, thereby minimizing any potential leaking of exudates from the package 100. Additionally, the disjoinable area 112 may be made to weaken preferentially with respect to the end seals 120 and/or any other sealed areas, for example, the end portions 122 of the center seal 118, such that the disjoinable area 112 tends to disjoin while the remaining sealed areas 120, 122 remain intact. For example, the other sealed areas 120, 122 may be made to be substantially transparent to microwave energy (e.g., substantially devoid of microwave energy interactive material), such that such areas remain substantially at ambient temperature during the heating cycle and are not prone to substantial softening.

FIG. 1D schematically illustrates an exemplary sheet 124 of packaging material that may be used to form the package 100 of FIGS. 1A-1C. The sheet 124 generally has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the sheet is manufactured or erected into a package. The sheet 124 may be substantially symmetrical along a longitudinal center line CL and a transverse centerline CT.

If desired, the sheet 124 may comprise a plurality of adjoined layers. In the illustrated example, a support layer 126 formed from, for example, paper, serves as an outermost layer of the packaging material, as shown in schematic partial cross-sectional view in FIG. 1E. The susceptor 114 overlies and/or may be joined to a portion of the support layer 126. In the example illustrated in FIG. 1D, the susceptor 114 overlies substantially the entire support layer 126 except for a pair transverse end areas 120 opposite one another. The susceptor 114 may be supported on a polymer film 128 that may at least partially define an innermost (e.g., food-contacting) surface 130 of the sheet 124.

To form the package 100 according to one exemplary method, the sheet of packaging material 124 may be folded over itself along longitudinal guide lines 132, 134, which may comprise fold lines, score lines, or other suitable lines of disruption. One of the end areas 120 may be overlapped and joined to itself to define one of the end seals 120. Opposed side edge areas 108, 110 defined by longitudinal guide lines 136, 138 then may be brought together in a facing, contacting relationship and joined to one another to form the center seal 118, as best seen in FIGS. 1A-1C, and to define the interior space 102 (FIG. 1B) for receiving the food item. The other end area 120 then may be overlapped and joined to itself to define the second end seal 120. It will be noted that in this example, two layers of the susceptor 114 lie within the disjoinable area 112 of the center seal 118. However, it will be understood that a single layer or additional layers may be used in other embodiments to achieve the desired effect.

Any of the sealed areas may be sealed adhesively, may be sealed thermally (i.e. heat sealed), or may be joined in any other suitable manner. In one example, the disjoinable area 112 may be formed using an adhesive or adhesive material (e.g., a thermoplastic adhesive material) that functions to adhere when the adhesive material is relatively cool, and that softens in response to increased temperature, such that the adhesive bond weakens in response to thermal energy (i.e., heat) emanating from, for example, the susceptor in substantially close proximity to the adhesive. In another particular example, disjoinable area 112 may comprise a thermoplastic polymer that is thermally bonded to itself, such that the bond weakens in response to thermal energy, for example, emanating from the susceptor in substantially close proximity to the bond. In one specific example, the thermoplastic polymer is an amorphous polyurethane.

A food item may be inserted into the interior space 102 of the package 100 at any suitable time during the process. The polymer film 128 at least partially defines an interior surface 130 of the package 100 (FIG. 1B) for contacting the food item. In this example, the susceptor 114 generally overlies the food-contacting area of the interior surface 130 and the portion of the center seal 118 defined by the side edge areas 108, 110 of the sheet 124, as schematically indicated with dashed lines in FIG. 1B.

In use, the package 100 may be positioned with the center seal 118 as the uppermost portion of the package 100 in the microwave oven. The susceptor 114 converts at least a portion of the impinging microwave energy to thermal energy, which then can be transferred to the surface of the adjacent food item to enhance browning and/or crisping. The heat generated by the susceptor 114 along the disjoinable area 112 generally causes the bond between the adjoined side edge areas 108, 110 to weaken. At the same time, water vapor and other gases generated within the package 100 may exert a pressure on the weakened center seal 102. As a result, the side edge areas 108, 110 may at least partially disjoin or disengage from one another to form the venting opening 116, thereby releasing the pressure within the package 100. Since there is no susceptor along the end seals 120, the end seals 120 generally remain intact. In this manner, the package 100 may be designed to provide preferential weakening of the specific bonded areas accompanied by controlled formation of venting openings. Further, it is noted that since any venting openings tend to form along the center seal 118 above the food item, there is little risk of the food item (e.g., any sauces, liquids, or other exudates) leaking from the package 100.

As will be appreciated, the degree of bonding along the fin seal or any other selected seal, the susceptor area and configuration, and the type of package can be selected to provide the desired degree of disengagement and accompanying venting. For example, susceptor 114 may be included in a smaller portion of the center seal 118, only a relatively small portion of the center seal 118 is the disjoinable area 112.

Numerous other microwave heating packages are encompassed by the disclosure. Any of such structures may be formed from various materials, provided that the materials are substantially resistant to softening, scorching, combusting, or degrading at typical microwave oven heating temperatures, for example, at from about 250° F. to about 425° F. The materials may include microwave energy interactive materials, for example, those used to form susceptors and other microwave energy interactive elements, and microwave energy transparent or inactive materials, for example, those used to form the remainder of the construct.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

While susceptors are illustrated herein, the package alternatively or additionally may include a foil or high optical density evaporated material having a thickness sufficient to reflect a substantial portion of impinging microwave energy. Such elements are typically formed from a conductive, reflective metal or metal alloy, for example, aluminum, copper, or stainless steel, in the form of a solid “patch” generally having a thickness of from about 0.000285 inches to about 0.05 inches, for example, from about 0.0003 inches to about 0.03 inches. Other such elements may have a thickness of from about 0.00035 inches to about 0.020 inches, for example, 0.016 inches.

Larger microwave energy reflecting elements may be used where the food item is prone to scorching or drying out during heating. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The breaks or apertures may extend through the entire structure, or only through one or more layers. The number, shape, size, and positioning of such breaks or apertures may vary for a particular application depending on the type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in one or more layers or materials used to form the construct, or may be a non-physical “aperture”. A non-physical aperture is a microwave energy transparent area that allows microwave energy to pass through the structure without an actual void or hole cut through the structure. Such areas may be formed by simply not applying a microwave energy interactive material to the particular area, or by removing microwave energy interactive material in the particular area, or by chemically and/or mechanically deactivating the microwave energy interactive material in the particular area. While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive (i.e., microwave energy transparent) area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance heating, browning, and/or crisping.

In some instances, it may be beneficial to create one or more discontinuities or inactive regions to prevent overheating or charring of the construct. Such areas may be formed by forming these areas of the construct without a microwave energy interactive material, by removing any microwave energy interactive material that has been applied, or by deactivating the microwave energy interactive material in these areas, as discussed above.

Further still, one or more panels, portions of panels, or portions of the construct may be designed to be microwave energy inactive to ensure that the microwave energy is focused efficiently on the areas to be heated, browned, and/or crisped, rather than being lost to portions of the food item not intended to be browned and/or crisped or to the heating environment. This may be achieved using any suitable technique, such as those described above.

As stated above, the microwave energy interactive element may be supported on a microwave inactive or transparent substrate 128 (FIG. 1E), for example, a polymer film or other suitable polymeric material, for ease of handling and/or to prevent contact between the microwave energy interactive material and the food item. The outermost surface of the polymer film 128 may define at least a portion of the food-contacting surface 130 of the package 100, as indicated in FIG. 1B. Examples of polymer films that may be suitable include, but are not limited to, polyolefins, polyesters, polyamides, polyimides, polysulfones, polyether ketones, cellophanes, or any combination thereof. In one particular example, the polymer film comprises polyethylene terephthalate. The thickness of the film generally may be from about 35 gauge to about 10 mil. In each of various examples, the thickness of the film may be from about 40 to about 80 gauge, from about 45 to about 50 gauge, about 48 gauge, or any other suitable thickness. Other non-conducting substrate materials such as paper and paper laminates, metal oxides, silicates, cellulosics, or any combination thereof, also may be used.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating including circles, loops, hexagons, islands, squares, rectangles, octagons, and so forth.

Various materials may serve as the base material 132 (FIG. 1E) for the construct 100. For example, the construct may be formed at least partially from a polymer or polymeric material. As another example, all or a portion the construct may be formed from a paper or paperboard material. In one example, the paper has a basis weight of from about 15 to about 60 lbs/ream (lb/3000 sq. ft.), for example, from about 20 to about 40 lbs/ream. In another example, the paper has a basis weight of about 25 lbs/ream. In another example, the paperboard having a basis weight of from about 60 to about 330 lbs/ream, for example, from about 155 to about 265 lbs/ream. In one particular example, the paperboard has a basis weight of about 175 lbs/ream. The paperboard generally may have a thickness of from about 6 to about 30 mils, for example, from about 14 to about 24 mils. In one particular example, the paperboard has a thickness of about 16 mils. Any suitable paperboard may be used, for example, a solid bleached or solid unbleached sulfate board, such as SUS® board, commercially available from Graphic Packaging International.

The package may be formed according to numerous processes known to those in the art, including using adhesive bonding, thermal bonding, ultrasonic bonding, mechanical stitching, or any other suitable process. Any of the various components used to form the package may be provided as a sheet of material, a roll of material, or a die cut material in the shape of the package to be formed (e.g., a blank).

It will be understood that with some combinations of elements and materials, the microwave energy interactive element may have a grey or silver color that is visually distinguishable from the substrate or the support. However, in some instances, it may be desirable to provide a package having a uniform color and/or appearance. Such a package may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave energy interactive element to the support, using a silver or grey toned support to mask the presence of the silver or grey toned microwave energy interactive element, using a dark toned substrate, for example, a black toned substrate, to conceal the presence of the silver or grey toned microwave energy interactive element, overprinting the metallized side of the polymer film with a silver or grey toned ink to obscure the color variation, printing the non-metallized side of the polymer film with a silver or grey ink or other concealing color in a suitable pattern or as a solid color layer to mask or conceal the presence of the microwave energy interactive element, or any other suitable technique or combination of techniques.

The disclosure may be understood further from the following example, which is not intended to be limiting in any manner.

### EXAMPLE

Fin seal susceptor pouches were prepared from 48 gauge metalized polyethylene terephthalate film adhesively joined to 25 lb/ream grease resistant paper. A first pouch 200 was formed from a packaging material 202 schematically illustrated in FIG. 2A, such that the susceptor 204 (schematically illustrated with stippling) extended into the end seal areas 206, as shown schematically in FIG. 2B, but not in the fin seal area 208. In a second pouch, the susceptor extended into the fin seal area, but not in the end seal areas, as schematically depicted in FIGS. 1A-1C. Both pouches had finished dimensions of about 5 in. by about 9 in. and were formed from a sheet of material having size of about 9 in. by about 11 in. Wet paper towels were placed into each pouch and the pouches were sealed. Each pouch was then heated separately in a 1000 W microwave oven until the respective pouch began to open up and vent the water vapor inside.

Notably, the first pouch vented along the end seals, while the second pouch vented along the fin seal, as shown schematically in FIG. 1B. Some scorching was observed along the fin seal in the second pouch, presumably because of the presence of two susceptors in the fin seal area. It is believed that the use of susceptor along only one of the edge areas (i.e. marginal or peripheral areas) that form the fin seal might mitigate any overheating that might occur.

It also is noted that the first pouch vented near the ends of the end seal where there were two susceptors in a facing relationship with one another, rather than in the middle of the end seal where there was only one susceptor facing the unmetallized portion of the fin seal. Thus, using two susceptors may generate sufficiently more heat to provide a preferential point of venting as compared with a single susceptor.

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A package for heating, browning, and/or crisping a food item in a microwave oven, comprising:
a packaging material configured to define an interior space for receiving a food item, at least two portions of the packaging material being joined to one another to define a sealed area adapted to be situated above a lowermost portion of the food item received in the interior space, the sealed area being configured to weaken in response to thermal energy; and
a microwave energy interactive material joined to a side of the packaging material facing the interior space, at least a portion of the microwave energy interactive material being disposed within the sealed area.

2. The package of claim 1, wherein the sealed area comprises a material having a softening point of from about 250° F. to about 450° F.

3. The package of claim 1, wherein the sealed area comprises a thermoplastic polymer.

4. The package of claim 1, wherein the sealed area comprises an amorphous polyurethane.

5. The package of claim 1, wherein
the package includes a pair of end seals opposite one another and a center seal extending substantially between the end seals, and
the sealed area comprises at least a portion of the center seal.

6. The package of claim 5, wherein the end seals are substantially transparent to microwave energy.

7. The package of claim 5, wherein the end seals are substantially devoid of microwave energy interactive material.

8. The package of claim 1, wherein the microwave energy interactive material comprises a layer of aluminum having an optical density of from about 0.15 to about 0.35, the layer of aluminum being operative for converting at least a portion of impinging microwave energy into thermal energy.

9. A package for heating, browning, and/or crisping a food item in a microwave oven, comprising:
a base configured to underlie a food item for heating in a microwave oven;
an upper portion adapted to overlie the food item, the upper portion including a sealed area configured to weaken in response to thermal energy; and
a susceptor disposed within the sealed area, the susceptor being operative for converting microwave energy into thermal energy for weakening the sealed area.

10. The package of claim 9, wherein the sealed area comprises a material having a softening point of at least about 250° F.

11. The package of claim 9, wherein the sealed area comprises a thermoplastic polymer.

12. The package of claim 9, wherein the sealed area comprises an amorphous polyurethane.

13. The package of claim 9, wherein
the sealed area is a first sealed area, and
the package includes a second sealed area, the second sealed area being substantially transparent to microwave energy.

14. The package of claim 9, wherein the second sealed area is substantially devoid of microwave energy interactive material.

15. The package of claim 9, wherein the second sealed area is proximate to the base.

16. The package of claim 9, wherein
the sealed area is a first sealed area of a plurality of sealed areas, and
the first sealed area is adapted to selectively disjoin upon sufficient exposure to microwave energy prior to the other sealed areas of the plurality of sealed areas.

17. The package of claim 9, wherein
the base and the upper portion at least partially define an interior space for receiving the food item, and
the susceptor is further disposed on a side of at least one of the base and the upper portion facing the interior space.

18. The package of claim 9, wherein the susceptor comprises a layer of aluminum having a thickness of from about 60 to about 100 angstroms.

19. A method of preparing a food item in a microwave oven, comprising:
providing a package for receiving the food item, the package including
a base for underlying the food item,
an upper portion for overlying the food item, the upper portion including a sealed area that weakens in response to thermal energy, and
a susceptor disposed within the sealed area;
exposing the food item in the package to microwave energy, whereby the susceptor converts at least a portion of the microwave energy to thermal energy, whereby the thermal energy weakens the seal and creates a venting opening.

20. The method of claim 19, wherein exposing the food item in the package to microwave energy causes the food item to generate steam, the steam exerting a pressure on the weakened seal to create the venting opening.
